(19) United States
(12) Patent Application Publication
(10) Pub. No.: US 2002/0127382 A1
(43) Pub. Date: Sep. 12, 2002

(54) Multilayer composite film and use of this film

(76) Inventor: Etienne Susini, Villecresnes (FR)

Correspondence Address: HENDERSON & STURM LLP, 1213 MIDLAND BUILDING, 206 SIXTH AVENUE, DES MOINES, IA, 50309-4076, US

(21) Appl. No.: 09/875,482

(22) Filed: Jun. 6, 2001

Related U.S. Application Data
(63) Continuation of application No. PCT/IB99/01930, filed on Dec. 3, 1999.

(30) Foreign Application Priority Data
Dec. 7, 1999 (EP) EP 98420226.7

(51) Int. Cl. B32B 7/02

(52) U.S. Cl. 428/218

(57) ABSTRACT

The invention concerns a multilayer composite film for packaging food comprising a PP layer sandwiched between two outer PE layers Said film thickness ranges between 30 &mgr;m and 120 &mgr;m the outer layers being made of LLDPE whereof the density d is 0.919<d<0.930 g/cm 3 and the median layer being made of a mixture comprising 50-70% of PP whereof the density d is 0.895<d<0.905 g/cm 3, whereof the melt index ranges between 0.75 and 0.85 g/10 minutes, 10-30% of said LLDPE and 10-30% of a thermoplastic polyolefin whereof the density d is 0.885<d<0.905 g/m 3 and whereof the melt index is between 0.55 and 0.65g/10 minutes.

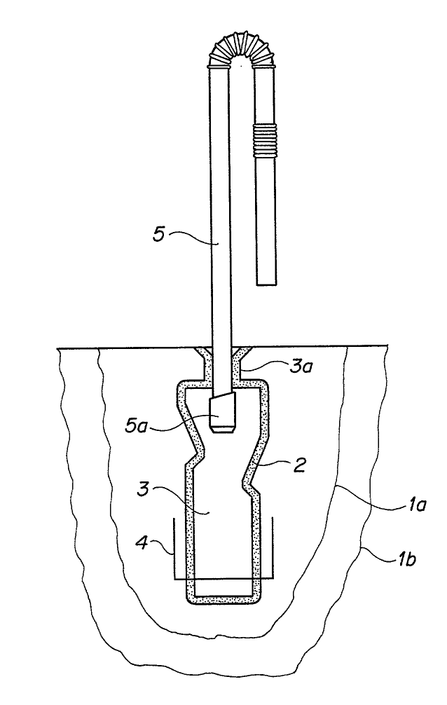

The present invention relates to a multilayer composite film of food grade quality, the thickness of which is between 30 μm and 120 μm, comprising a layer based on PP sandwiched between two outside layers of LLDPE, the density d of which is between 0.919<d<0.930 g/cm³, and to a use of this film.

Multilayer composite films are well known and are generally intended to combine the physical or chemical properties of various polymer materials according to the desired properties.

EP 0 247 896 discloses a weldable film comprising a base layer which contains a polyolefin, which on at least one of its sides has 1 to 20% by weight based on the base layer of a film containing a blend of 70 to 95% by weight of an LLDPE and 5 to 30% by weight of a resin with a molecular weight lower than that of the LLDPE.

Another weldable multilayer film based on polypropylene comprising at least one outside layer of LLDPE of which the density is from 0.893-0.905 g/cm³, the melt index from 0.1-10 g/10 minutes and containing up to 20% of a comonomer, in JP 09 207294. [sic] JP 09 314769 describes a weldable film comprising a film of flexible resin of the polypropylene type onto the opposite faces of which LLDPE films are laminated.

JP 10 272747 relates to a stretchable film with three layers or more comprising, at its surface, a layer of LLDPE and a layer of amorphous copolymer and, by way of middle layer, a blend of polypropylene (C), of poly(1-butene) (D) in a ratio (C)/(D) =0.10-9.0. A surfactant of nonionic type is combined with one or more of the layers.

U.S. Pat. No. 5 085 927 proposes to increase the molding property of a stretchable film by adding an elastomer compound in addition to the adhesion promoters which in themselves increase the molding properties of the film.

Elsewhere, particularly in WO 98/28199, there has been proposed a sachet for packaging liquid, comprising a valve for controlling the dispensing of the liquid, consisting of the superposition of two films welded along two non-converging lines to form a dispensing passage by the parting of these two films. This passage preferably has an entry passageway, the perimeter of which corresponds to that of a straw, the end of which is bulged. This film has enough elasticity to allow it to expand as this straw is being introduced and to then close up around it to prevent it from being withdrawn from said passage. The straw is thus secured to the sachet and can only be withdrawn by the amount necessary to allow the passage forming the valve to close.

The material of the film forming the valve has therefore to have enough elasticity to close up around the straw while at the same time allowing the bulged part to pass. This film has to be compatible with drinks and therefore meet standards relating to food products. As a preference, this material has to maintain its properties even after it has been subjected to a temperature of between 80° and 90° C., which is frequently that of the drink at the time that it is packaged in the sachet.

The combination of all these properties, some of which are contradictory, is not easy to achieve even with combinations of several layers of different polymers. In particular, none of the abovementioned documents of the prior art allows these properties to be combined.

It is an object of the present invention to obtain a film capable of meeting at least the main requirements, that is to say, in addition to the properties of flexibility needed to allow the passage that forms the valve to close in a sealed manner, the properties of elasticity and of compatibility with food standards. As a preference, the film according to the invention should withstand the temperature of the liquid to be packaged, which may be as high as 80° or even 90°, while keeping its flexibility and elasticity properties intact.

To this end, a very first subject of the invention is a multilayer composite film of the abovementioned type as defined by claim 1. Another subject is a use of this film as defined by claim 7. Various preferred embodiments of the composite film correspond to the definitions given in the claims dependent on claim 1.

Tests carried out with the multilayer film that is the subject of the present invention have shown that such a film makes it possible to meet all the abovementioned requirements, both as regards the valve and as regards the ability to hold the straw in the valve passage and obviously to introduce this straw into this passage. This film also allows all these properties to be maintained after the liquid has been packaged at a temperature of at least 80° C. and which may be as high as 90° C.

The invention will be better understood upon reading the examples which follow.

According to one embodiment, the two outside layers of the multilayer film that is the subject of the present invention are made of an LLDPE (Linear Low Density Polyethylene), Dow Elite® 5110, the density d of which is 0.925 g/cm³ and the melt index MI of which is 0.85 g/10 minutes according to the ASTM D 1238 standard, measurements taken at 230° C., applying a mass of 2.16 kg, with a standard nozzle 2.095 mm in diameter, with the Vicat softening temperature T°ᵥ, being 113° C. As a preference, a slip agent, in this example 900 ppm of Erucamide® which is a derivative of erucic acid, the molecule of which is cis-13-docosenamide, is added to at least one of the two outside layers of the film, that is to say to the one which will be on the inside of the passage forming the valve and which will therefore be in contact with the straw for withdrawing the liquid so as to make it easier to slide inside the passage forming the valve produced using the film that is the subject of the present invention.

The middle layer of this film sandwiched between the abovementioned outside layers consists of a blend of 60% of PP, Moplen® EP-Q 30RF by Himont, a heterophasic copolymer the density d of which is 0.9 g/m³, the melt index MI of which is 0.8 g/10 minutes according to ASTM D 1238/L and the Vicat softening temperature T°ᵥ of which is 150° C. This middle layer also contains 20% of the LLDPE used to form the two abovementioned outside layers and 20% of a thermoplastic polyolefin, Adflex® Q100F manufactured by Himont, the density d of which is 0.89 g/cm³ and the melt index MI of which is 0.6 g/10 minutes according to ASTM D 1238.

The role of this thermoplastic polyolefin is to provide the polypropylene with enough elasticity to allow the film forming the valve and, in particular, the entry passage opening into the actual valve proper, to deform elastically when a bulged retaining part of the straw for withdrawing the liquid passes as it is introduced into this valve. What happens is that the length of the perimeter of this entry passage is chosen to correspond to that of the perimeter of this straw, so that once the bulged retaining part of this straw has been introduced, the passage closes up around the straw and prevents it from coming back out.

This middle layer of the film that is the subject of this invention also has the role of giving this film resistance to a temperature of 80° or to 90° C., so as to allow the enclosures or sachets, to which the valve formed by the film that is the subject of the present invention is attached, to be filled with drinks packaged at such temperatures. This hot-filling is performed for all sorts of drinks, particularly milk or milk-based drinks, and fruit juices. It must maintain its properties, particularly its elastic properties, after the drink has been hot-packaged.

The film thus manufactured has also to be able to be welded without the welding causing it to degrade, that is to say that the film has to maintain its food compatibility with the drinks packaged.

The various tests carried out to develop this multilayer film have made it possible to observe that while the thickness of the film can be varied in a fairly broad range depending on the requirement, from 30 μm to about 120 μm. [sic] The thickness of the film is preferably as thin as possible so as to allow for high manufacturing rates. However, as the film is made up of three layers, it is necessary for the thicknesses of the respective layers to remain great enough that they can be extruded. In addition, as the middle layer is preferably thicker than each of the outside layers, it is not possible in practice for it to drop below 30 μm. In the example produced, the film had a thickness of 40 μm, with a middle layer of 20 μm and two outside layers of 10 μm.

To allow the valve formed from the film that is the subject of this invention to close properly, this film has to have good flexibility. In the case of the LLDPE that forms the outside layers and forms part of the composition of the central layer, the flexibility is a function of the density d. This is why LLDPE was chosen, the density d of which can vary slightly within a range of between 0.919<d<0.930 g/cm³. For PP, the flexibility is a function of the density and of the melt index MI. The density d can vary between 0.895<d<0.905 g/cm³, while the melt index can vary between 0.75 and 0.85.

The Vicat temperature which is the softening temperature of the material, has to not differ too widely between the various layers in order to allow them to be coextruded. In the abovementioned example, the Vicat point T°ᵥ of the LLDPE must be greater than 100° C., while that of the PP must be less than 160° C. As a preference, these temperatures are between 110° and 150° C.

The proportion of slip agent, in this example Erucamide®, has to be less than 1300 ppm. Although this slip agent is needed only in the layer of the multilayer film adjacent to the face of this sheet that is intended to be situated on the inside of the valve passage, it is preferable for it to be incorporated into both outside layers, given that it is very difficult later to distinguish between these two outside layers and that there might therefore be a risk of the film being turned the wrong way up. By having both sides identical, this problem no longer exists.

As a preference, the film according to the invention, at least in its specific use for making the abovementioned valve, is not subjected to any corona oxidation treatment.

The single figure of the appended drawing depicts schematically and by way of example a plan view of a valve produced using a multilayer film that is the subject of the present invention.

This valve is intended to be inside a container, particularly a sealed sachet, not depicted, intended for packaging a liquid, particularly a drink. This figure shows two thicknesses 1a, 1b of this film which have been superposed. These two thicknesses of the film 1a, 1b are united by a weld line 2, creating between them a passage 3 forming the dispensing valve. A cut 4 allows the passage 3 to communicate with the outside, that is to say with the contents of the container. This passage 3 is normally closed, the two thicknesses of film 1a, 1b being contiguous. It is by introducing an element to part them that the valve opens and liquid can therefore flow between the inside of the container and the outside along the passage 3. The element used to open the passage 3 is itself formed by a pipe, particularly by a straw 5.

The end of this straw has a bulge 5a, as described in EP 98420015.4. The entry portion 3a of the valve passage 3 is narrowed and has a perimeter corresponding to that of the straw 5, so that this entry portion 3a fits around this straw 5 and opposes the passage of the bulged part 5a. In order to allow the straw 5 to be introduced through this narrowed entry portion 3a, the front end of the bulged part 5a of the straw 5 has a cross section that increases gradually, while the rear of this bulged part is connected by a bearing surface to the cylindrical part of the straw 5, which prevents it from coming back out through the entry portion 3a of the passage 3.

In order to obtain this fit of the entry portion 3a of the passage 3 around the straw, while however allowing the bulged part 5a to pass, the multilayer film 1a, 1b forming this valve has to have enough elasticity to close up again around the straw 5 once this bulged part 5a has passed. This is, in particular, on of the roles of the multilayer film that is the subject of the invention.

1. Multilayer composite film of food grade quality, the thickness of which is between 30 μm and 120 μm, comprising a layer based on PP sandwiched between two outside layers of LLDPE, the density d of which is between 0.919<d<0.930 g/cm³, characterized in the [sic] middle layer contains 50-70% by weight of PP the density d of which is 0.895<d<0.905 g/cm³ and the melt index of which is between 0.75 and 0.85 g/10 minutes, 10-30% by weight of said LLDPE and 10-30% by weight of a thermoplastic polyolefin the density d of which is 0.885<d<0.905 g/cm³ and the melt index of which is between 0.55 and 0.65 g/10 minutes.

2. Composite film according to claim 1, characterized in that the Vicat temperature T°ᵥ of the LLDPE is greater than 100° C., while that of the PP is less than 160° C.

3. Composite film according to one of the preceding claims, characterized in that its thickness is less than 60 μm.

4. Composite film according to one of the preceding claims, characterized in that the thickness of the middle layer is practically twice that of each of the two outside layers.

5. Composite film according to one of the preceding claims, characterized in that it is not subjected to any corona oxidation treatment.

6. Composite film according to one of the preceding claims, characterized in that less than 1300 ppm of a slip agent of the Erucamide® type is added to at least one of the outside layers of said film.

7. Use of the composite film according to one of the preceding claims to form a valve for controlling the dispensing of a drink, consisting of the superposition of two layers (1a, 1b) of said film welded along two non-converging lines (2) to form a distribution passage (3) by parting said layers (1a, 1b), the perimeter of the entry section (3a) of this distribution passage (3) corresponding to that of a withdrawing pipe (5) intended to part said layers (1a, 1b) so as to fit around this withdrawing pipe (5), this film having enough elasticity to allow a bulge (5a) of gradually increasing cross section, belonging to said withdrawing pipe (5) and followed by a bearing surface connecting this bulge (5a) to said withdrawing pipe (5a [sic]) to be introduced, preventing it from being withdrawn from said passage (3).

8. Use according to claim 7, characterized in that said outside layer of said film, to which a slip agent is added, is the layer adjacent to said passage (3).
